(19) United States
(12) Patent Application Publication
(10) Pub. No.: US 2013/0247705 A1
(43) Pub. Date: Sep. 26, 2013

(54) SHIFTING APPARATUS FOR MANUAL TRANSMISSION

(71) Applicants: HYUNDAI MOTOR COMPANY, Seoul (KR); KIA MOTORS CORPORATION, Seoul (KR)

(72) Inventor: Youngbae Ryu, Seoul (KR)

(73) Assignees: Kia Motors Corporation, Seoul (KR); Hyundai Motor Company, Seoul (KR)

(21) Appl. No.: 13/849,032

(22) Filed: Mar. 22, 2013

(30) Foreign Application Priority Data
Mar. 26, 2012 (KR) 10-2012-0030786

(51) Int. Cl. G05G 1/04

(52) U.S. Cl. CPC G05G 1/04
USPC 74/473.33

(57) ABSTRACT

A shifting apparatus for a manual transmission which transmits shifting operations of a shift lever to the transmission and includes a control shaft rotatably and movably mounted to a control housing may include a control body which may be mounted to the control shaft and may be rotated with the control shaft or moved along an axial direction of the control shaft with the control shaft according to selecting operating or shifting operation, wherein a shift groove and a select groove may be formed to one side and the other side of the control body, and a stopper protruded on an inward side of the control housing corresponding to the control body for supporting the rotated control body along circumferential direction thereof.

### CROSS-REFERENCE TO RELATED APPLICATION

The present application claims priority to Korean Patent Application No. 10-2012-0030786 filed on Mar. 26, 2012, the entire contents of which is incorporated herein for all purposes by this reference.

### BACKGROUND OF THE INVENTION

1. Field of the Invention

The present invention relates to a shifting apparatus for a manual transmission. More particularly, the present invention relates to a shifting apparatus for a manual transmission that may prevent from deteriorating of shift feel due to clearance (or gap) of shifting by supporting a control body rotated by a control shaft after shifting.

2. Description of Related Art

In general, a transmission for converting a motive power of an engine to an appropriate driving power is installed in a vehicle and a shifting apparatus for operating the transmission is installed in the vehicle.

The shifting apparatus applied to the manual transmission, which transmits an operating force of the shifting lever to the manual transmission to achieve a shift, is constituted by a selecting cable and a shifting cable transmitting the operating force by the shifting operation of the shifting lever, a control shaft assembly connected with the selecting and shifting cables, and a shift fork assembly mounted between the control shaft assembly and a synchronizing device of the transmission to perform shifting by operating the synchronizing device according to operating of the control shaft assembly.

When a driver manipulates a shift lever, a shift lever and a select lever connected to a control cable are operated. And then a control shaft rotates and/or moves axial direction so that the control shaft assembly is operated.

The control shaft assembly operates a shift rail and a shift fork applying shifting force to the synchronizing devices disposed corresponding to each shift ranges, and thus driving torque of an engine is appropriately applied for each running state of a vehicle.

However, in a conventional art, the shifting apparatus may have clearance (or gap) of shifting (or mechanical clearance) due to clearances between a shift finger and a rug and between a fork and a sleeve. So after rotation of the control shaft, the control shaft may move along rotating direction and thus shift feel may be deteriorated.

It may be considered to mount a separated stopper for supporting against rotation direction of the control shaft, however, layout within the transmission may be complicated and manufacturing cost may be increased due to increasing of constituent elements.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a shifting apparatus for a manual transmission having advantages of preventing deterioration of shift feel due to rotation of a control shaft according to clearance of shifting or mechanical clearance by forming a stopper to a control housing for supporting a control body rotating with the control shaft in shift manipulation. Also, an exemplary embodiment of the present invention provides a shifting apparatus for a manual transmission which may simplify layout and constitutional elements and reduce manufacturing cost.

In an aspect of the present invention, a shifting apparatus for a manual transmission which transmits shifting operations of a shift lever to the transmission and may include a control shaft rotatably and movably mounted to a control housing, may include a control body which is mounted to the control shaft and is rotated with the control shaft or moved along an axial direction of the control shaft with the control shaft according to selecting operating or shifting operation, wherein a shift groove and a select groove are formed to one side and the other side of the control body, and a stopper protruded on an inward side of the control housing corresponding to the control body for supporting the rotated control body along circumferential direction thereof.

Support protrusions are extendedly formed at both edges of the one side of the control body where the shift groove is formed.

Support portions are formed at the stopper, and each of the support protrusions selectively contacts a corresponding support portion of the support portions.

Each of the support portions is a slanted surface inclined toward the control body.

The stopper is a pair corresponding to each support protrusion.

The shifting apparatus may further include detent units mounted to the stopper, wherein the shift groove and the select groove contact a corresponding detent unit of the dent units respectively in the shifting operation.

Each of the dent units is disposed between the support portions and is substantially symmetrically-disposed with respect to both of the support portions.

According to an exemplary embodiment of the present invention, the shifting apparatus for a manual transmission may prevent deterioration of shift feel due to rotation of a control shaft according to clearance of shifting or mechanical clearance by forming a stopper to a control housing for supporting a control body rotating with the control shaft in shift manipulation.

Also, the shifting apparatus for a manual transmission may simplify layout and constitutional elements and reduce manufacturing cost without separated units for preventing rotation.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a perspective view of a shifting apparatus for a manual transmission according to an exemplary embodiment of the present invention.

FIG. 2 is a enlarged view of A of FIG. 1.

FIG. 3 is a perspective view of a control body applied to a shifting apparatus for a manual transmission according to an exemplary embodiment of the present invention.

FIG. 4 is a view showing operations of a shifting apparatus for a manual transmission according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

An exemplary embodiment of the present invention will hereinafter be described in detail with reference to the accompanying drawings.

Exemplary embodiments described in the present specification and a configuration shown in the drawings are just the most preferable exemplary embodiment of the present invention, but are not limited to the spirit and scope of the present invention. Therefore, it should be understood that there may be various equivalents and modifications capable of replacing them at the time of filing of the present application.

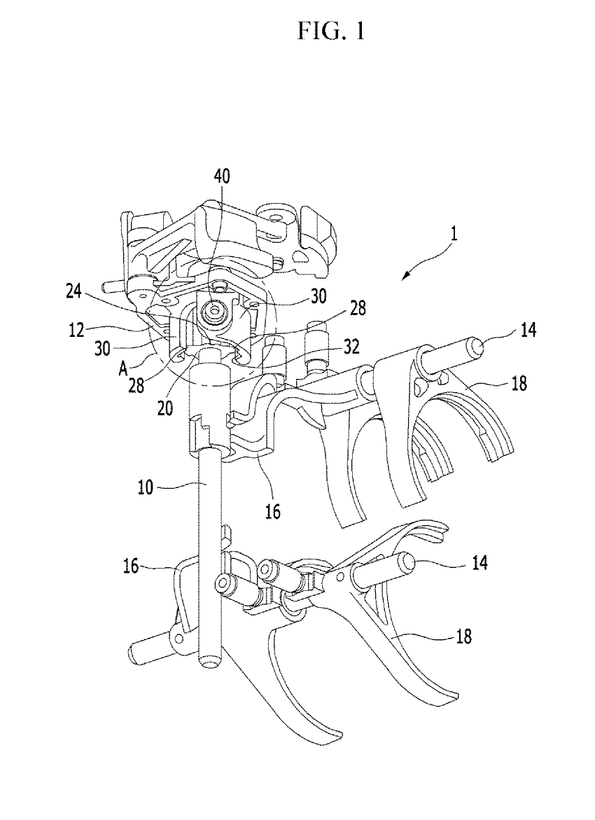

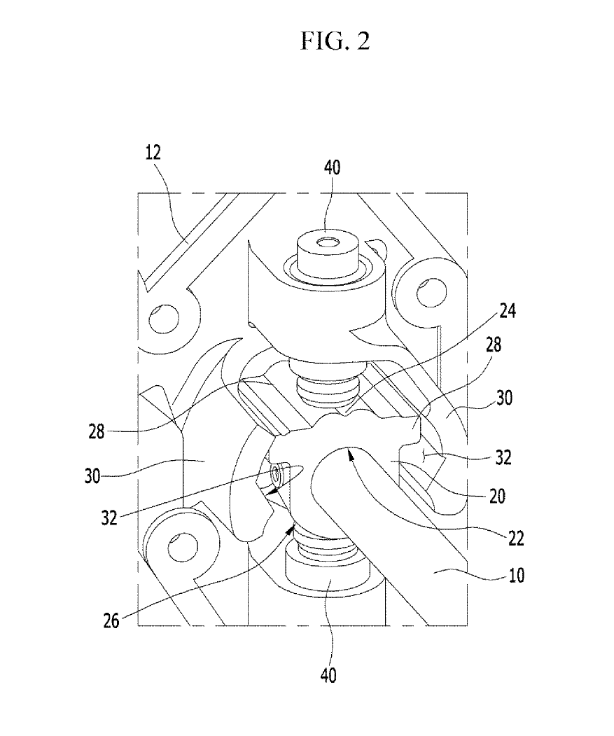

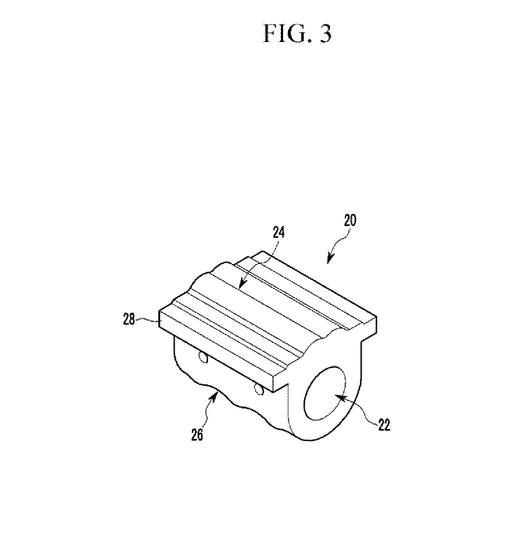

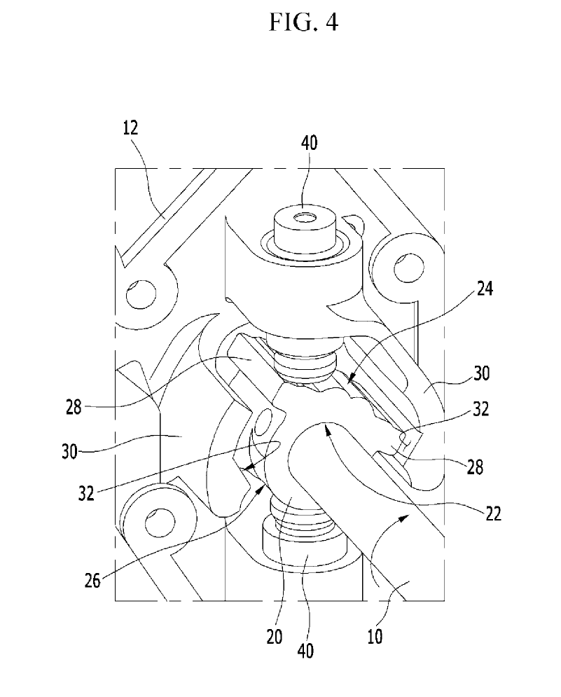

FIG. 1 is a perspective view of a shifting apparatus for a manual transmission according to an exemplary embodiment of the present invention, and FIG. 2 is a enlarged view of A of FIG. 1. FIG. 3 is a perspective view of a control body applied to a shifting apparatus for a manual transmission according to an exemplary embodiment of the present invention, and FIG. 4 is a view showing operations of a shifting apparatus for a manual transmission according to an exemplary embodiment of the present invention.

A shifting apparatus 1 for a manual transmission according to an exemplary embodiment of the present invention, as shown in FIG. 1, includes a control shaft 10, for transmitting shift force or shift operation of a non-illustrated shift lever to a transmission, which is rotatably and movably mounted to a control housing 12.

When the control shaft 10 rotates and/or reciprocates in a straight line, the control shaft 10 operates a shift rail 14 which transmitting shifting force to a synchronizing device including a shift lug 16 and a fork 18 disposed to each shift ranges and thus shifting operation is executed.

The shifting apparatus 1 according to an exemplary embodiment of the present invention further includes, as shown in FIG. 2 and FIG. 3, a control body 20 and a stopper 30 and detailed description will be followed.

The control body 20 is mounted to the control shaft 10 and selectively rotates and/or moves axial direction together with the control shaft 10 according to select operations and shift operation, and a shift groove 24 and a select groove 26 are formed to one and the other side of the control body 20.

In the control body 20, a mounting hole 22 for the control shaft 10 to be inserted thereinto and mounted thereto is formed to the control body 20, support protrusions 28 are extendedly formed at both edges of the one side of the control body 20 where the shift groove 24 is formed.

The support protrusions 28 are extended outwardly respectively from the upper portion of the shift groove 24.

The control body 20 mounted to the control shaft 10 through the mounting hole 22 is disposed adjacent to the control housing 12.

The stopper 30 is integrally protruded on the inward side of the control housing 12 corresponding to the control body 20 for selectively supporting the rotated control body 20 along circumferential direction thereof.

The stopper 30 is protruded toward the control body 20, and covers the control body 20 rotatable within the stopper 30.

The stopper 30 may be formed as a pair corresponding to each support protrusion 28 formed to the control body 20 and a support portion 32 may be formed integrally corresponding to each support protrusion 28.

In the present exemplary embodiment, the support portion 32 may be a slanted surface which is slantly formed for stably supporting the rotated control body 20 by contacting the support protrusion 28 of the control body 20.

In the present exemplary embodiment, the shift groove 24 and the select groove 26 may contact detent units 40 respectively which are mounted to the stopper 30.

Hereinafter, operations of the shifting apparatus 1 for a manual transmission according to an exemplary embodiment of the present invention will be discussed.

FIG. 4 is a view showing operations of a shifting apparatus for a manual transmission according to an exemplary embodiment of the present invention.

The control shaft 10 of the shifting apparatus 1 rotates in shifting operation when a driver manipulates a shift lever, and simultaneously the control body 20 rotates together with the control shaft 10.

The support protrusions 28 rotated with the control body 20, as shown in FIG. 4, contact the support portion 32 formed as slanted surfaces insides of the stopper 30, so that the support protrusions 28 are stably supported.

That is, after rotation of the control shaft 10, the support portion 32 of the stopper 30 prevents the control body 20 from being rotated further. Thus the control body 20 may not be excessively rotated even though there is clearance of shifting or mechanical clearance between a shift finger and the shift rug 16 and between the shift fork 18 and a sleeve.

Thus, the shifting apparatus 1 for a manual transmission an exemplary embodiment of the present invention may prevent deterioration of shift feel due to rotation of the control shaft 01 according to clearance of shifting or mechanical clearance by disposing the stopper 30 provided with the support portion 32 for supporting the control body 20 rotating with the control shaft 10 in shift manipulation.

Also, the shifting apparatus 1 for a manual transmission an exemplary embodiment of the present invention may simplify layout and constitutional elements and reduce manufacturing cost without separated units for preventing rotation.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. They are not intended to be exhaustive or to limit the invention to the precise forms disclosed, and obviously many modifications and variations are possible in light of the above teachings as well as various alternatives and modifications thereof. It is intended that the scope of the invention be defined by the Claims appended hereto and their equivalents.

What is claimed is:

1. A shifting apparatus for a manual transmission which transmits shifting operations of a shift lever to the transmission and includes a control shaft rotatably and movably mounted to a control housing, the shifting apparatus comprising:
a control body which is mounted to the control shaft and is rotated with the control shaft or moved along an axial direction of the control shaft with the control shaft according to selecting operating or shifting operation, wherein a shift groove and a select groove are formed to one side and the other side of the control body; and
a stopper protruded on an inward side of the control housing corresponding to the control body for supporting the rotated control body along circumferential direction thereof.

2. The shifting apparatus of claim 1, wherein support protrusions are extendedly formed at both edges of the one side of the control body where the shift groove is formed.

3. The shifting apparatus of claim 2,
wherein support portions are formed at the stopper, and
wherein each of the support protrusions selectively contacts a corresponding support portion of the support portions.

4. The shifting apparatus of claim 3, wherein each of the support portions is a slanted surface inclined toward the control body.

5. The shifting apparatus of claim 2, wherein the stopper is a pair corresponding to each support protrusion.

6. The shifting apparatus of claim 1, further including detent units mounted to the stopper, and
wherein the shift groove and the select groove contact a corresponding detent unit of the dent units respectively in the shifting operation.

7. The shifting apparatus of claim 6, wherein each of the dent units is disposed between the support portions and is substantially symmetrically-disposed with respect to both of the support portions.
